(19) United States
(12) Patent Application Publication
(10) Pub. No.: US 2013/0204801 A1
(43) Pub. Date: Aug. 8, 2013

(54) COMPUTER-IMPLEMENTED SYSTEM AND METHOD FOR FACILITATING THE PERFORMANCE OF SERVICES IN EXCHANGE FOR CHARITABLE CONTRIBUTIONS

(71) Applicant: Voolla, Inc., Virginia Beach, VA (US)

(72) Inventor: Stephanie Downs, Washington, DC (US)

(73) Assignee: Voolla, Inc., Virginia Beach, VA (US)

(21) Appl. No.: 13/751,618

(22) Filed: Jan. 28, 2013

Related U.S. Application Data
(60) Provisional application No. 61/594,385, filed on Feb. 3, 2012.

(51) Int. Cl. G06Q 30/02

(52) U.S. Cl. CPC G06Q 30/0279
USPC 705/329

(57) ABSTRACT

A computer-implemented system and method for facilitating agreements negotiated by users of the system to exchange professional services in return for charitable contributions. The system allows a first user to locate another user who can perform a service requested by the first user or who requires a service that the first user can provide, and facilitates the negotiation of a contract where the service is performed in exchange for a contribution being made to one or more charitable non-profit organizations, without the user performing the service being subjected to income tax liability for the contribution.

### CROSS-REFERENCE TO RELATED APPLICATIONS

This application claims the benefit under 35 U.S.C. §119(e) of U.S. Provisional Patent Application No. 61/594,385, filed Feb. 3, 2012, herein incorporated by reference in its entirety.

### TECHNICAL FIELD

The present invention pertains to computer-implemented systems and methods for facilitating charitable contributions to non-profit organizations in exchange for the performance of services. More particularly, the present invention is directed towards allowing users of computing devices to access a computer-implemented system to reach an agreement, wherein a first user agrees to perform at least one service in exchange for a second user making a contribution to at least one non-profit organization approved by the computer-implemented system.

### BACKGROUND OF THE INVENTION

Every year, millions of Americans donate their time and money to non-profit charitable organizations. There are many ways in which individuals and business can currently contribute to a charitable cause: making donations through the mail, over the phone, online, or in person, or by volunteering their time at an organized event or through a non-profit organization.

However, there remains a need for systems and methods that can facilitate even more donations of time and money to worthy charitable causes. Many individuals who wish to support a charity lack the financial means necessary to donate as much as they would prefer. Moreover, even volunteering one's time can be an arduous affair. Willing individuals may not have any local opportunities that match the often-valuable skills they could provide to charitable non-profit organizations, or the organization that an individual wishes to benefit may not have a need for the particular skills of that individual. Organizing and hosting charitable events can require hours of preparation and sometimes result in little to no benefit to the charity itself.

Traditional methods of charitable giving place burdens on non-profit organizations as well. While larger, well-known organizations are able to advertise and attract large donations on the national and even global level, smaller charities face difficulties in promoting their message and attracting donors outside of their local region and existing base of support.

Existing systems have sought to remedy these problems by providing different ways for individuals to donate to charities. For example, existing Internet auction sites allow those selling merchandise to donate the proceeds of their sales to charitable non-profit organizations. However, the very nature of these sites means that only those who already possess or can afford the auctioned items can participate in charitable giving, which does nothing to help those who wish to support a charity but are financially unable to do so.

Online marketplaces also exist in which users can market their skills and services to potential employers who are in need of such services. However, these existing marketplace systems are ill-suited to the context of charitable giving and do not remedy the issues inherent in traditional methods of donating to charity. Compensation for the jobs agreed to via these online marketplaces is paid directly to the freelance employees, subjecting that compensation to tax liability that could be avoided if the money was donated directly to the charity. Moreover, these systems cannot aid in determining which charity (or charities) the money is to be donated to, nor aid lesser-known charities with promotion and advertising. Finally, these systems require that users be classified in rigid categories as an employee or employer, preventing individuals or firms using these systems from both donating their time as well as their money.

As discussed above, existing systems and methods of donating time and/or money to charitable non-profit organizations suffer from several deficiencies. Existing online auction sites with charitable giving options only cater to individuals who have the financial capability to make monetary donations to non-profit agencies, and do not aid those who wish to support a charity by volunteering. Moreover, existing marketplaces for freelance workers are by their nature incompatible with the goal of charitable giving, and do nothing to aid lesser-known charities in gaining recognition and visibility. As a result, there is a need for systems and methods for facilitating charitable contributions that do not suffer from the drawbacks common to these traditional and existing systems and methods. The present invention, which is described in detail below, solves the need in the art for such systems and methods.

### SUMMARY OF THE INVENTION

The present invention is directed, in certain embodiments, to computer-implemented systems for facilitating the performance of services in exchange for charitable contributions, comprising at least one server providing access to the computer implemented system, at least one database comprising profiles for a plurality of users and records for a plurality of approved non-profit organizations, a first computing device utilized by a first user, the first user having a profile in the computer-implemented system, to access the computer-implemented system, a second computing device utilized by a second user, the second user having a profile in the computer-implemented system, to access the computer-implemented system, wherein the first user and second user reach an agreement, via the computer-implemented system, the agreement comprising the performance of at least one service by the first user in exchange for a contribution to at least one of the plurality of approved non-profit organizations by the second user.

In certain embodiments of the invention, the first user's profile in the computer implemented system comprises at least one service offered by the first user. In certain further embodiments of the invention, the first user's profile further comprises at least one service requested by the first user.

In certain embodiments of the invention, the second user's profile in the computer-implemented system comprises at least one service requested by the second user. In certain further embodiments of the invention, the second user's profile further comprises at least one service offered by the second user.

In certain embodiments of the invention, the first and second computing devices are computing devices selected from the group consisting of desktop computers, laptop computers, mobile computers, tablet computers, cellular telephones, smartphones, internet-enabled televisions, personal digital assistants, and video game consoles.

In certain embodiments of the invention, the plurality of users comprise individuals, businesses, and non-profit organizations.

In certain embodiments of the invention, the server provides access to the computer-implemented system via one or more of a website, an official application, a plugin, and/or a third-party application.

In certain embodiments of the invention, the computer-implemented system further comprises a third computing device utilized by an approved non-profit organization to access the computer-implemented system.

In certain embodiments of the invention, the agreement further comprises a payment by the second user to the first user.

In certain embodiments of the invention, the at least one of the plurality of approved non-profit organizations is selected by one of the group consisting of the first user, the second user, and the computer-implemented system.

In certain embodiments of the invention, the contribution to at least one of the plurality of approved non-profit organizations comprises a contribution to multiple approved non-profit organizations. In certain further embodiments of the invention, each of the multiple approved non-profit organizations receives from 1% to 99% of the total amount of the contribution to the multiple approved non-profit organizations. In certain further embodiments of the invention, one of the multiple approved non-profit organizations is the operator of the computer-implemented system. In certain further embodiments of the invention, a first one of the multiple approved non-profit organizations is selected by the first user, and a second one of the multiple approved non-profit organizations is selected by the second user.

In certain embodiments of the invention, at least one of the profiles of the first user and the second user comprises a user selection of at least one user-preferred non-profit organization from the plurality of approved non-profit organizations. In certain further embodiments of the invention, the computer-implemented system suggests one or more approved non-profit organizations similar to the at least one user-preferred non-profit organization. In still further embodiments of the invention, the first user's profile comprises a first user-preferred non-profit organization, the second user's profile comprises a second user-preferred non-profit organization, and the contribution to at least one of the plurality of approved non-profit organizations is a contribution to a non-profit organization similar to both the first user-preferred non-profit organization and the second user-preferred non-profit organization and suggested by the computer-implemented system.

In certain embodiments of the invention, the computer-implemented system further comprises a financial fiduciary account for holding at least a portion of the contribution until the performance of the at least one service is completed.

In certain embodiments of the invention, the computer-implemented system is operated by a non-profit organization.

The present invention is directed, in certain embodiments, to computer-implemented methods for facilitating the performance of services in exchange for charitable contributions, comprising a first user having a profile on a computer-implemented system utilizing a first computing device to access the computerized system, a second user having a profile on the computer-implemented system utilizing a second computing device to access the computer-implemented system, and the first user and the second user reaching an agreement, via the computer-implemented system, the agreement comprising the performance of at least one service by the first user in exchange for a contribution to at least one of the plurality of non-profit organizations by the second user.

In certain embodiments of the invention, the first user is not subject to income tax liability for the contribution made by the second user in exchange for the at least one service performed by the first user.

### BRIEF DESCRIPTION OF THE DRAWINGS

FIG. 1A is a schematic diagram of the components of the computer-implemented system of the present invention, as exemplified by a certain preferred embodiment of the computer-implemented system operated by the non-profit organization, Voolla, Inc., referred to herein as “the Voolla® system.” Voolla® is a registered trademark of Voolla, Inc.

FIG. 1B is a diagram illustrating interaction between users of the Voolla® system.

FIG. 2 depicts the contents of an exemplary profile of a volunteer user.

FIG. 3 depicts the contents of an exemplary profile of a customer user.

FIG. 4 depicts the contents of an exemplary profile of a user who is both a customer and a volunteer.

FIG. 5 is a flowchart illustrating the process of registering as a user of the Voolla® system.

FIG. 6 is a flowchart illustrating the process of responding to a posted service.

FIG. 7 is a flowchart illustrating the process of responding to a posted help wanted ad.

FIG. 8 is a flowchart illustrating the process of contacting a user having a profile in the Voolla® system.

FIG. 9 depicts the contents of a service request.

FIG. 10 is a flowchart illustrating the process of negotiating the terms of a service request.

FIG. 11 is a diagram illustrating an exemplary transaction negotiated via the Voolla® system.

### DETAILED DESCRIPTION OF THE INVENTION

The present invention is directed towards systems and methods for facilitating the performance of services in exchange for charitable contributions.

To ensure clarity in the following detailed description, the following definitions are provided.

As used herein, the “Voolla® system” refers to a certain preferred embodiment of the computer-implemented system operated by the non-profit organization Voolla, Inc. Voolla® is a registered trademark of Voolla, Inc.

As used herein, the phrase “official application” refers to an application developed by the operator of the computer-implemented system which the application is configured to access.

As used herein, the phrase “third-party application” refers to an application developed by an entity different than the operator of the computer-implemented system which the application is configured to access.

As used herein, the term “customer” refers to a user of the Voolla® system who is seeking one or more services to be provided.

As used herein, the term “volunteer” refers to a user of the Voolla® system who is offering to provide one or more services.

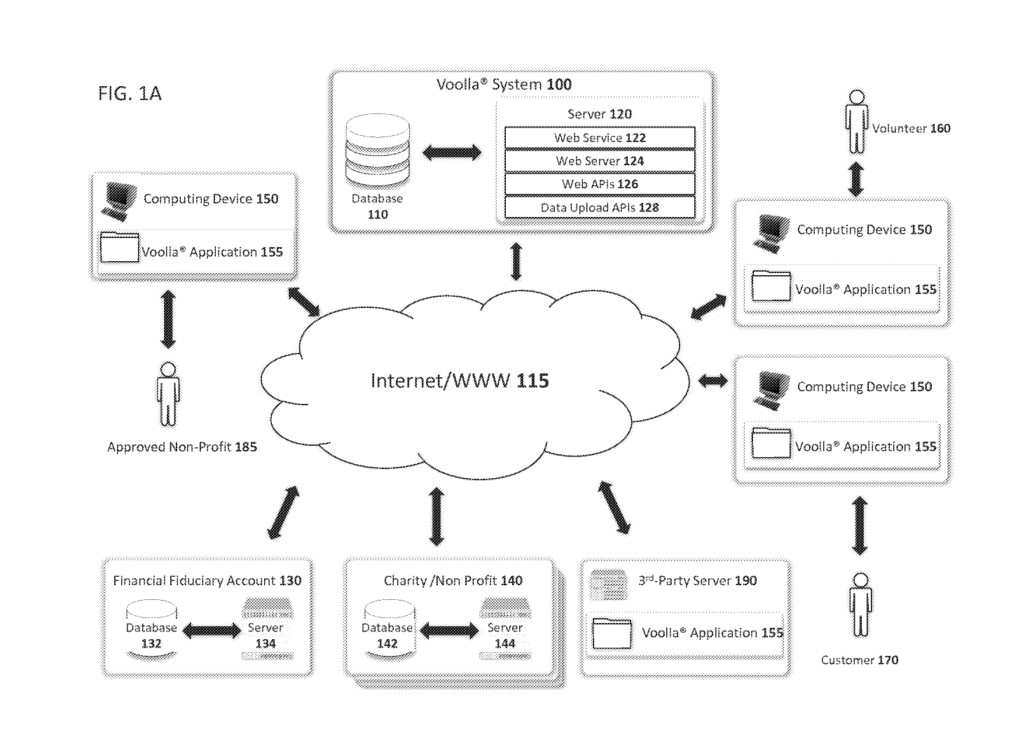

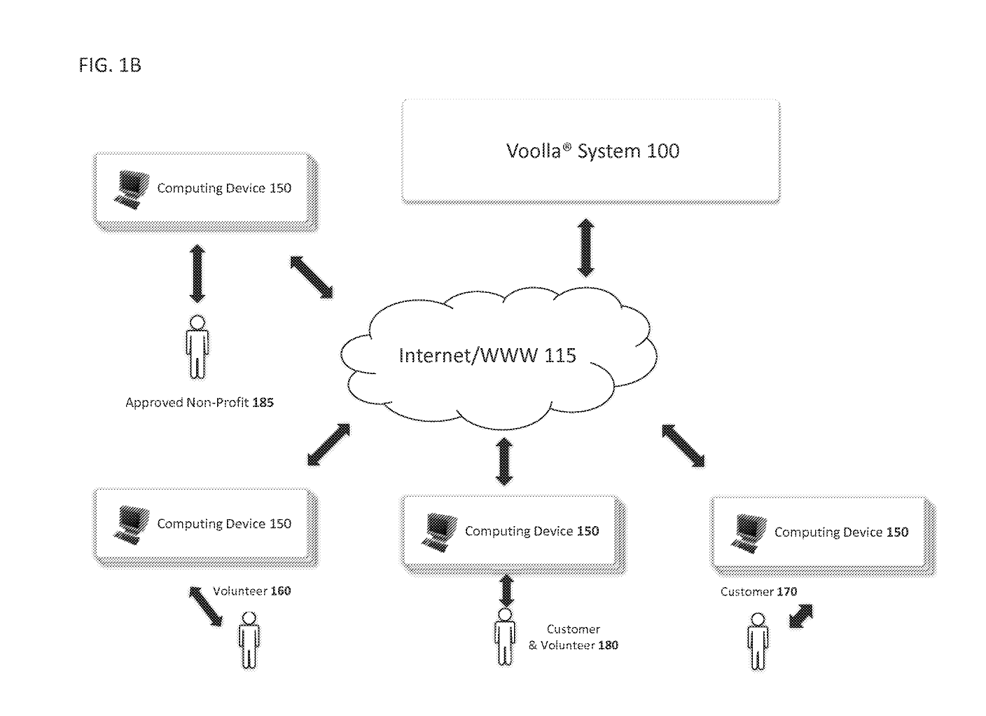

FIG. 1A illustrates a schematic view of the Voolla® system 100, an exemplary preferred embodiment of the computer-implemented systems and methods of the present invention. In this preferred embodiment, the Voolla® system 100 comprises one or more databases 110 and one or more servers 120.

In certain preferred embodiments of the present invention, the one or more databases 110 of the Voolla® system 100 contain a collection of data. In preferred embodiments, the database 110 contains data including but not limited to user profiles for customer users 170, profile data for volunteer users 160, profile data for users who are both volunteers and customers 180 (shown in FIG. 1B), data on non-profit organizations 185, and other types of data related to the users 160 and 170 of the Voolla® system 100 and the non-profit organizations 185. It will be readily apparent to one skilled in the art that the databases 110 can contain other similar types of data and information as well.

In certain preferred embodiments, the server 120, as well as financial fiduciary account server 134, charitable non-profit organization server 144, and third-party server 190, is implemented as a server program executed on one or more desktop computer, laptop computer, or server-class computer comprising a CPU, memory, network interface, peripheral interfaces and other well-known components. Of course, other types of computers can be used as the server 120, and it will be readily apparent to one skilled in the art that as more powerful computers are developed in the future, they can be configured in accordance with the teachings here. The functionality implemented by the server computers 120 can also be provided from computer program products that are stored in computer readable storage media (e.g., RAM, hard disk, optical/magnetic media, and/or other types of computer-readable media).

In certain preferred embodiments, the server 120 executes a plurality of programs and applications, including but not limited to a web service 122, a web server 124, web APIs 126, and data upload APIs 128. The web services 122, web servers 124, web APIs 126, and data upload APIs 128 are used by the server 120 to communicate with client devices, such as computing devices 150, financial fiduciary account servers 134, charity/non-profit servers 144, 3rd-party system servers 190, and other client devices over a network 115.

In preferred embodiments, the network 115 over which server 120 communicates with client devices 134, 144, 150, and/or 190 is the Internet and/or World Wide Web. However, in other embodiments of the present invention, the network 115 may be any type of network, including but not limited to an intranet, a LAN, a MAN, a WAN, a mobile, wired, or wireless network, a private network, a virtual private network (VPN), or any other type of network or combination thereof.

The network 115 can include links using technologies such as Wi-Fi, Wi-Max, 2G, Universal Mobile Telecommunications System (UMTS), 3G, 4G, Ethernet, 802.11, integrated services digital network (ISDN), digital subscriber line (DSL), asynchronous transfer mode (ATM), InfiniBand, PCI Express Advanced Switching, and other networking technologies.

Similarly, the networking protocols used on network 115 can include the transmission control protocol/Internet protocol (TCP/IP), multi-protocol label switching (MPLS), the User Datagram Protocol (UDP), the hypertext transport protocol (HTTP), the simple mail transfer protocol (SMTP), the file transfer protocol (FTP), lightweight directory access protocol (LDAP), Code Division Multiple Access (CDMA), Wideband Code Division Multiple Access (WCDMA), Global System for Mobile Communications (GSM), High-Speed Downlink Packet Access (HSDPA), and other networking protocols.

The data exchanged over network 115 can be represented using technologies and/or formats including the hypertext markup language (HTML), the extensible markup language (XML), and other formats. In addition, all or some of the network connections can be encrypted using conventional encryption technologies such as the secure sockets layer (SSL), Secure HTTP, virtual private networks (VPN), Internet Protocol security (IPsec), and/or any similar encryption technologies.

In certain preferred embodiments, the computing devices 150 used by volunteers 160, customers 170, and approved non-profit organizations 185 are computing devices selected from the group consisting of desktop computers, laptop computers, mobile computers, tablet computers, cellular telephones, smartphones, internet-enabled televisions, personal digital assistants, and video game consoles. However, it would be obvious to those skilled in the art that the computing devices 150 could be any type of computing device capable of communicating, either via a wired or wireless connection 115, with the system 100.

In various preferred embodiments of the present invention, the computing devices 150 operated by users of the system (e.g., volunteers 160, customers 170, or approved non-profit organizations 185) communicate with system 100 to execute an application 155 to access the Voolla® system 100. In certain preferred embodiments, the application 155 is a WWW/Internet browser configured to access an Internet or web site for system 100 provided by server 120.

In other preferred embodiments, the application 155 is an official application (or “app”) developed by the operators of system 100, the official application being configured to communicate with server 120 to receive and transmit data. In certain other embodiments, application 155 is a plugin application. In preferred embodiments of the invention, the application 155 for accessing Voolla® system 100 will be different depending on what third-party server 190 the official application or plugin application is designed for. In a certain exemplary embodiment, there may be a first version of application 155 designed to be incorporated into third-party systems 190 providing social media web sites such as Facebook® or LinkedIn®, as well as a second version of application 155 designed to be incorporated into third-party systems 190 providing job board web sites such as CareerBuilder® and freelance marketplace websites such as Guru.com® or eLance®.

In certain embodiments of the present invention, application 155 is a third-party application developed by an entity different than the operator of the computer-implemented system which the application is configured to access. In some embodiments, the third-party application is developed by utilizing an API published by the operator of system 100.

In certain embodiments of the present invention, the Voolla® web site comprises a web-based platform configured to execute a set of programs to interface with the devices, computers, and/or through the World Wide Web. The web-based platform includes one or more processors, computers, and/or servers to execute a set of programs for carrying out access to the web site, setting up and storing user information, or operations to perform a variety of services.

In certain embodiments of the invention, the web site operated by Voolla® system 100 comprises different views for different types of viewers. In certain exemplary embodiments, a volunteer 160 might have a slightly different view of the Voolla® system 100's web site than customer 170. In turn, both volunteer 160 and customer 170 will have a different view of the web site than approved non-profit organization 185. Furthermore, in certain other exemplary embodiments, administrators of the Voolla® system 100 have their own view of the system 100's web site. In certain preferred embodiments of the invention, an approved non-profit organization 185 can access a view of the Voolla® system 100 which allows that organization 185 to edit its profile page on the Voolla® system 100, view volunteers 160 and customers 170 who have listed the organization 185 as a charity of choice or who have donated services/contributed money for the organization 185, post pictures, text, video, and other media describing projects funded by the money raised through the Voolla® system 100, and view the total monetary amount raised for that organization 185 through the Voolla® system 100.

In certain preferred embodiments, the web site of Voolla® system 100 indexes the information contained in database 110 to both World Wide Web search engines as well as a search engine for the private Voolla® website maintained by the administrators of system 100. Therefore, in these embodiments, searches executed using a public World Wide Web search engine tool via a web browser as well as searches executed through a search tool of a graphical user interface page supplied by the web site of system 100 both can transmit and display results of volunteers 160, customers 170, and approved non-profits 185 matching a search query. The availability of records in the Voolla® system 100's database 110 to public search engines creates free marketing potential for volunteers 160, customers 170, and approved non-profits 185 utilizing the Voolla® system 100.

In certain exemplary embodiments of the present invention, the application 155 providing access to Voolla® system 100 may include a Showcase feature or function. This function allows volunteers 160, customers 170, or non-profits 185 to select information that can be displayed on a Showcase page or plugin provided by the Voolla® system 100. In certain embodiments, the Showcase feature can be a profile page, classified ad, or a simplified resume on the Voolla® system 100 website which is public and accessible through search engines. In other embodiments of the present invention, the Showcase feature is a plugin which can be incorporated into third-party websites to display selected volunteers 160 and their provided services as well as to display customers 170 and their proposed projects from the Voolla® system 100.

In certain exemplary embodiments of the present invention, the application 155 providing access to Voolla® system 100 may display a plurality of different features, including but not limited to top volunteers 160, top customers 170, a featured non-profit organization 185, a news feed featuring recent projects, money raised, updates from volunteers, advertising, an educational page with information about volunteering, sponsorships of Voolla® system 100, badges and/or rewards for volunteers 160, customers 170, and non-profit organizations 185, linked information from 3rd-party systems 190 such as Guidestar®, Facebook®, LinkedIn®, and YouTube®, pictures/videos posted from successful Voolla® projects, polls, opportunities for members of the public to donate to the Voolla® system 100, and other features. In certain embodiments of the present invention, the top volunteers 160 are those volunteers 160 who have donated their services to the greatest number of projects, have donated the greatest total monetary amounts of services, and/or have received the highest feedback ratings for the services they have donated. In certain embodiments of the present invention, the top customers 170 are those customers 170 who have retained volunteers for the greatest number of projects and/or have contributed the greatest total monetary amounts to charities.

In certain preferred embodiments of the present invention, the Voolla® system 100 communicates with one or more servers 144 and databases 142 of one or more non-profit organizations 140. In preferred embodiments, the non-profit organizations 140 are verified to be eligible to receive charitable contributions, and listed in IRS Publication 78, before they are approved by the system 100 as approved non-profit organizations 140. In a certain preferred embodiment, the Guidestar® system is utilized to verify the eligibility of non-profit organizations 140.

In certain preferred embodiments, non-profit organizations 140 can contact the administrators of Voolla® system 100 to request that their non-profit organizations 140 be verified and added to the database 110's collection of approved non-profit organizations. In further preferred embodiments of the system, the one or more non-profit organizations 140 may begin constructing their profile, page, and other aspects of their presence on the Voolla® system 100 while those organizations 140 wait to be formally verified and added by the administrators of the Voolla® system 100. In other preferred embodiments of the system, one or more non-profit organizations 140 may be verified and added to the database 110's collection of approved non-profit organizations on the initiative of the administrators of the Voolla® system 100. In other preferred embodiments of the system, customers 170 or volunteers 160 may request that one or more non-profit organizations 140 be verified and added to the database 110's collection of approved non-profit organizations.

In preferred embodiments of the present invention, the organization responsible for operating system 100 is a tax-exempt nonprofit organization under 26 U.S.C. §501(c) that is exempt from federal income taxes. In the preferred embodiments of the present invention, the tax-exempt status of the organization operating system 100 allows a user to donate his or her services in exchange for financial contributions being made by another user to system 100 without subjecting the user who donates his/her services to income tax liability.

In other embodiments of the present invention, the organization responsible for operating system 100 is a for-profit organization that is not exempt from federal income taxes. In these other embodiments, a user donating his or her services in exchange for financial contributions being made by another user through for-profit system 100 results in the user donating the services being subject to income tax liability for the amount of those financial contributions.

In certain preferred embodiments of the system, the Voolla® system 100 is also connected over network 115 to a financial fiduciary account 130's server 134 and database 132. The fiduciary account 130 is utilized by the Voolla® system 100 to hold funds provided by customers 170 until the services agreed to have been performed by volunteers 160. In certain embodiments of the system, the Voolla® system 100 requires that between 1% and 100% of the funds to be contributed by a customer 170 are provided to the fiduciary account 130 before the agreed-upon services are performed by volunteer 160. In embodiments of the present invention, the Voolla® system 100 may establish a threshold monetary amount for contributions, where contributions larger than the threshold amount may be subject to a payment plan that allows portions of the contribution to be provided by the customer 170 to the fiduciary account 130 over time.

In a certain preferred embodiment, the Voolla® system 100 requires that 100% of any contribution totaling less than $2500 be provided to the fiduciary account 130 before the agreed-upon services are performed by volunteer 160, and also requires that 50% of any contribution totaling $2500 or more be provided to the fiduciary account 130 before the agreed-upon services are performed by volunteer 160. In this certain preferred embodiment, contributions totaling $2500 or more are eligible for a payment plan to be negotiated between customer 170 and the Voolla® system 100. Once the services have been performed by volunteer 160, the funds contributed by customer 170 are released by the Voolla® system 100 to one or more non-profit organizations 140.

FIG. 1B illustrates interactions between users of the Voolla® system 100 in certain preferred embodiments of the Voolla® system 100. As discussed above, in preferred embodiments, volunteers 160, customers 170, and approved non-profit organizations 185 utilize computing devices 150 to communicate and interact through network 115 with each other and with the Voolla® system 100. However, in preferred embodiments of the present invention, users are not limited to being only a volunteer 160 or customer 170, but may play the role of both a customer & volunteer 180 depending on the particular project to be completed.

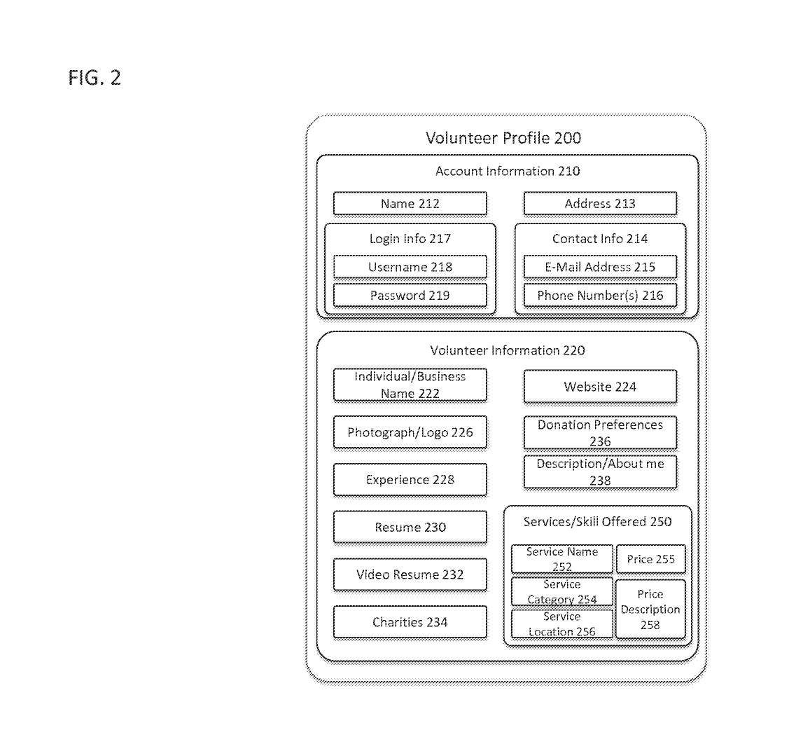

FIG. 2 illustrates an exemplary profile 200 in a preferred embodiment of the present invention for a volunteer 160. The volunteer profile 200 contains basic account information 210 for the volunteer 160, included but not limited to the volunteer 160's name 212, physical address 213, contact information 214 including the volunteer 160's e-mail address 215 and one or more telephone numbers 216, and login information 217 including a username 218 and password 219.

As illustrated in the exemplary volunteer profile 200, in preferred embodiments of the present invention, the volunteer profile 200 contains volunteer information 220. This volunteer information 220 includes, but is not limited to, the name of the volunteer or the volunteer's business/firm 222, a link to a personal/business website 224 for the volunteer 160, photographs/logos/images 226 posted or selected by the volunteer 160, a resume 230 and/or video resume 232, the experience level (including personal & professional references) 228 of the volunteer 160, and a personal description of the volunteer and/or the volunteer's business 238. In certain preferred embodiments of the invention, the volunteer profile 200 can contain ratings and feedback for the volunteer 160 based on services the volunteer 160 has performed in the past, examples of the volunteer 160's work, badges for completing certain amounts of work as a volunteer 160, a history of the volunteer 160's projects, and a length of time the volunteer 160 has been a user of the Voolla® system 100.

In preferred embodiments of the invention, the volunteer profile 200 comprises one or more approved non-profit charitable organizations (also referred to herein as charities) 234 that the volunteer 160 has selected as desired beneficiaries for contributions in return for work performed by the volunteer 160. These one or more selected non-profits 234 can be selected when the volunteer 160 initially sets up their profile 200, and can be changed at any time. In certain preferred embodiments of the invention, the Voolla® system 100 can suggest non-profit organizations to volunteer 160 to be selected as preferred non-profits 234 based on one or more of: past projects that volunteer 160 has worked on, similar charities 234 already selected by volunteer 160, non-profit organizations 234 selected by similar volunteers 160 on the Voolla® system 100, and/or non-profit organizations 234 that are popular selections across the Voolla® system 100 in general.

In certain preferred embodiments of the present invention, the exemplary volunteer profile 200 also comprises donation preferences 236 of the volunteer 160. The donation preferences 236 allow the volunteer 160 to specify which charities 234 will receive contributions in exchange for the one or more services 250 offered by the volunteer 160. In certain embodiments, the donation preferences 236 may specify that the contribution is to go to a single one of the charities 234, that multiple charities 234 are to benefit from a single contribution, or that particular ones of the charities 234 are to benefit from particular types of services offered 250. In preferred embodiments, the donation preferences 236 also contain a percentage of the total amount of the contribution that the volunteer 160 wishes the one or more charities 234 to receive. In certain embodiments, the percentage is selectable by volunteer 160 and ranges from 1%-100%.

In preferred embodiments of the present invention, the volunteer information 220 of the exemplary volunteer profile 200 further comprises one or more skills or services 250 offered by volunteer 160. In certain preferred embodiments, each one of the one or more skills or services 250 comprises a name of the service offered 252, a category/type of the service offered 254, a geographical location in which the service is available 256, a suggested price/valuation for the service 255, and a description/explanation 258 of what is included in the price 255 and service 250. In certain embodiments of the present invention, the Voolla® system 100 may suggest a price 255 and category 254 for a service 250 based on similar services offered by that particular volunteer 160 or by other volunteers.

In certain embodiments of the present invention, the one or more skills or services 250 offered by the volunteer 160 can be auctioned off by the volunteer 160 for charity through the Voolla® system 100. For example, the volunteer 160 could be a famous musician who donates their musical skills 250 (e.g., by giving music lessons or by playing at a private event) to benefit one or more charities 234 in a contribution amount determined by a publicly accessible auction conducted by the Voolla® system 100 for customers 170 of the Voolla® system 100.

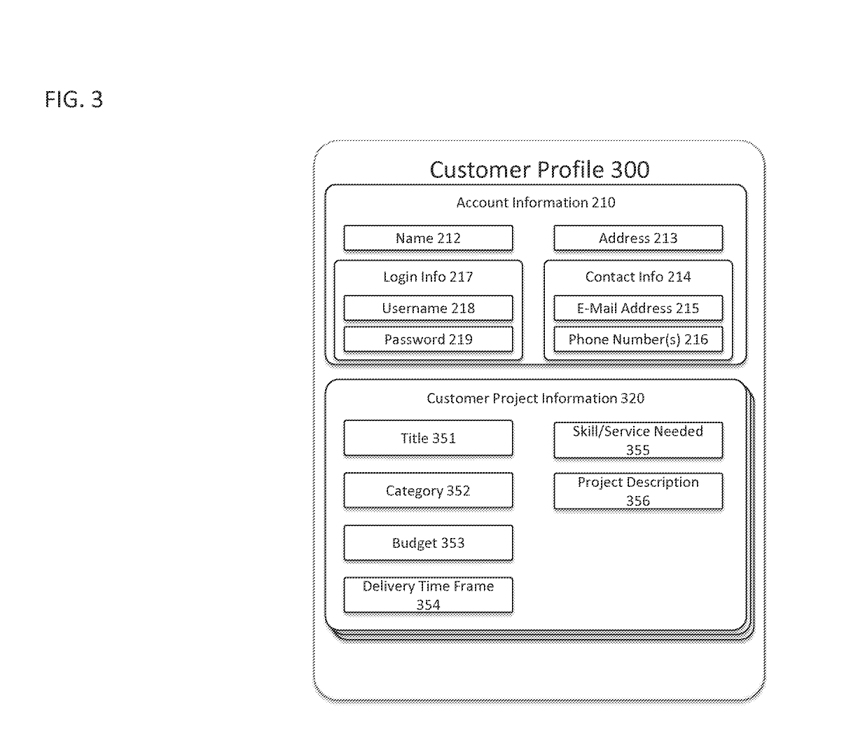

FIG. 3 illustrates an exemplary customer profile 300, in a preferred embodiment of the present invention, for a customer 170. As described above regarding the exemplary volunteer profile 200, the exemplary customer profile 300 also contains account information 210 for the user. Moreover, as depicted by the exemplary customer profile 300, in a preferred embodiment of the present invention, the profile 300 contains one or more pieces of information for customer project 320. Each group of information for customer project 320, in certain embodiments, comprises a title 351 of a project to be performed for customer 170, a category 352 of the project to be performed, a desired budget 353 for the project, a time frame for delivery of the project 354, a description of the skills/services needed for the project 355, and a description/explanation of the project 356. In certain embodiments of the present invention, the Voolla® system 100 may suggest a category 352 and budget 353 for a particular group of customer project information 320, based on similar projects proposed by that particular customer 170 or by other customers. In certain embodiments of the invention, a proposed project can also comprise a selected approved non-profit organization that is to benefit from the budget of the project, as well as donation preferences specifying a percentage of the project budget that is to go towards benefiting that selected non-profit organization and/or a percentage of the project budget that can be paid directly to compensate the one or more volunteers providing services for the project. In embodiments of the present invention, the customer profile 300 also may comprise a history of projects the customer 170 has contracted for, as well as the length of time the customer 170 has been a member of the Voolla® system 100 and the total amount of contributions made by that customer 170 to non-profit organizations.

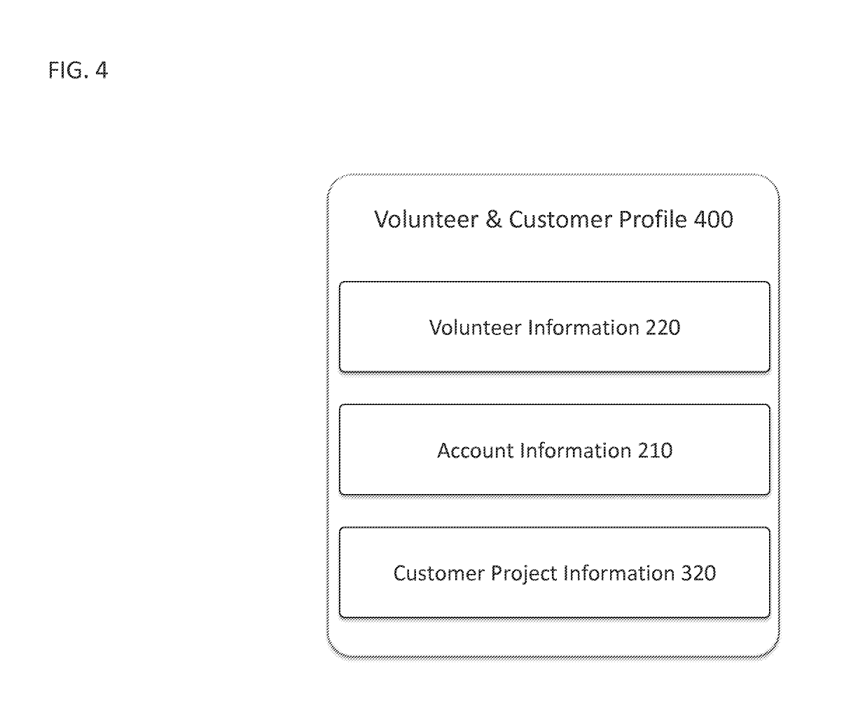

FIG. 4 illustrates an exemplary volunteer and customer profile 400, in a preferred embodiment of the present invention, for a user 180 who is both a volunteer and a customer. As illustrated by exemplary volunteer & customer profile 400, in preferred embodiments of the present invention, the profile 400 contains account information 210 as illustrated by FIG. 2, volunteer information 220 as illustrated by FIG. 2, and customer project information 320 as illustrated by FIG. 3.

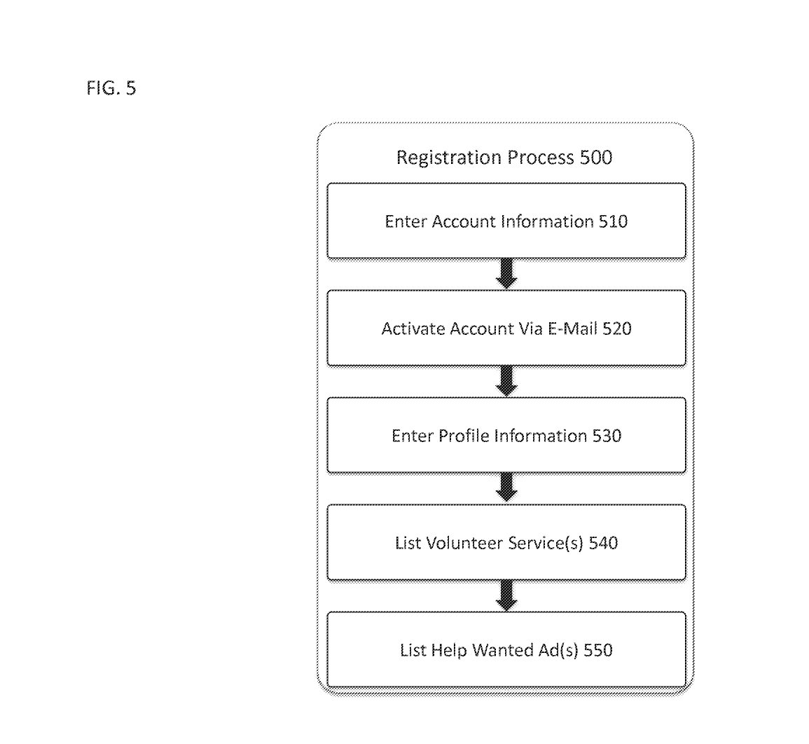

FIG. 5 is a flowchart that depicts an exemplary registration process 500 for users of a certain preferred embodiment of the Voolla® system 100. First, users begin in step 510 by inputting their personal account information, as illustrated by 210 of FIG. 2. In the following step 520, an activation e-mail is delivered to the e-mail address 215 entered by the user, which allows the user to activate their account in the system 100. After activation, the user can enter further information into their profile in step 530, list one or more volunteer services that the user is able to provide in step 540, and/or list one or more particular projects that the user proposes as a customer (such as, for example, to list one or more “Help Wanted Ad(s)”) in step 550.

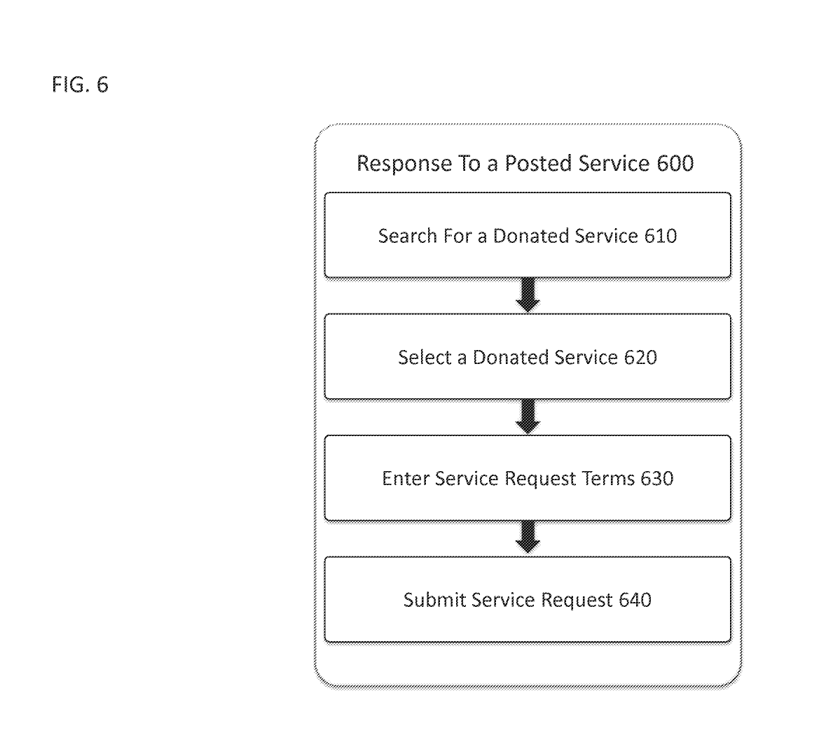

FIG. 6 is a flowchart illustrating an exemplary response 600 by a customer 170 to an offered service 250 posted by a volunteer 160. In certain preferred embodiments of the present invention, the response 600 begins when a customer 170 searches for services 250 offered for donation by volunteers 160 at step 610. As discussed above, in certain embodiments, the search 610 may be performed by entering a search query on a public Internet search engine or an internal search engine of the Voolla® system. In certain other embodiments of the present invention, the search 610 may comprise browsing through services 250 categorized by type or by geographical location. In other preferred embodiments of the present invention, the service 250 may be suggested to customer 170 by the Voolla® system 100 based on: previous or current projects proposed by customer 170; the service 250 offered by volunteer 160 matching criteria designated in an “alert” set by customer 170; or the service 250 being offered by a volunteer 160 who has selected the same or similar approved non-profit organizations 234 as customer 170. After the customer 170 selects a desired donated service 250 in step 620, the customer 170 can then enter the terms of a service request for the desired service at step 630 and submit that service request to the Voolla® system 100 at step 640 to begin the negotiation process with the volunteer 160 offering the selected donated service 250.

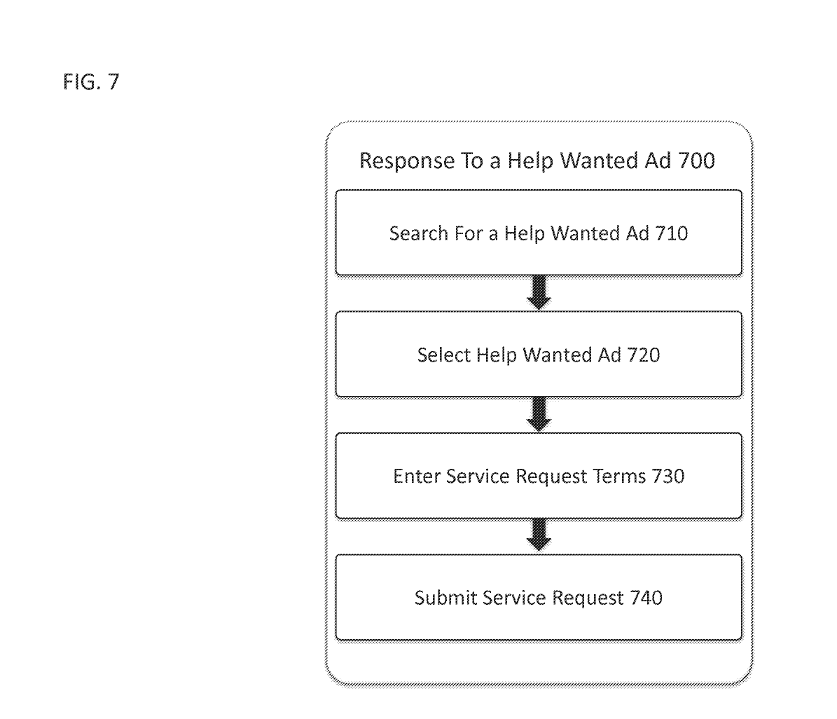

FIG. 7 is a flowchart illustrating an exemplary response 700 by a volunteer 160 to a help wanted advertisement posted by a customer 170 proposing a project 320. In certain preferred embodiments of the present invention, the response 700 begins when a volunteer 160 searches for projects 320 proposed by customers 170 at step 710, such as, for example, a search for a “Help Wanted Ad.” As discussed above, in certain embodiments, the search 710 may be performed by entering a search query on a public Internet search engine or an internal search engine of the Voolla® system 100. In certain other embodiments of the present invention, the search 710 may comprise browsing through projects 320 categorized by type or by geographical location. In other preferred embodiments of the present invention, the project 320 may be suggested to volunteer 160 by the Voolla® system 100 based on: previous or current projects 320 worked on by volunteer 160; the project 320 proposed by customer 170 matching criteria designated in an “alert” set by volunteer 160; or the project 320 being proposed by a customer 170 who has selected the same or similar approved non-profit organizations 234 as volunteer 160. After the volunteer 160 has selected a desired proposed project 320 in step 720, the volunteer 160 can then enter the terms of a service request for the desired proposed project at step 730 and submit that service request to the Voolla® system 100 at step 740 to begin the negotiation process with the customer 170 offering the desired proposed project 320.

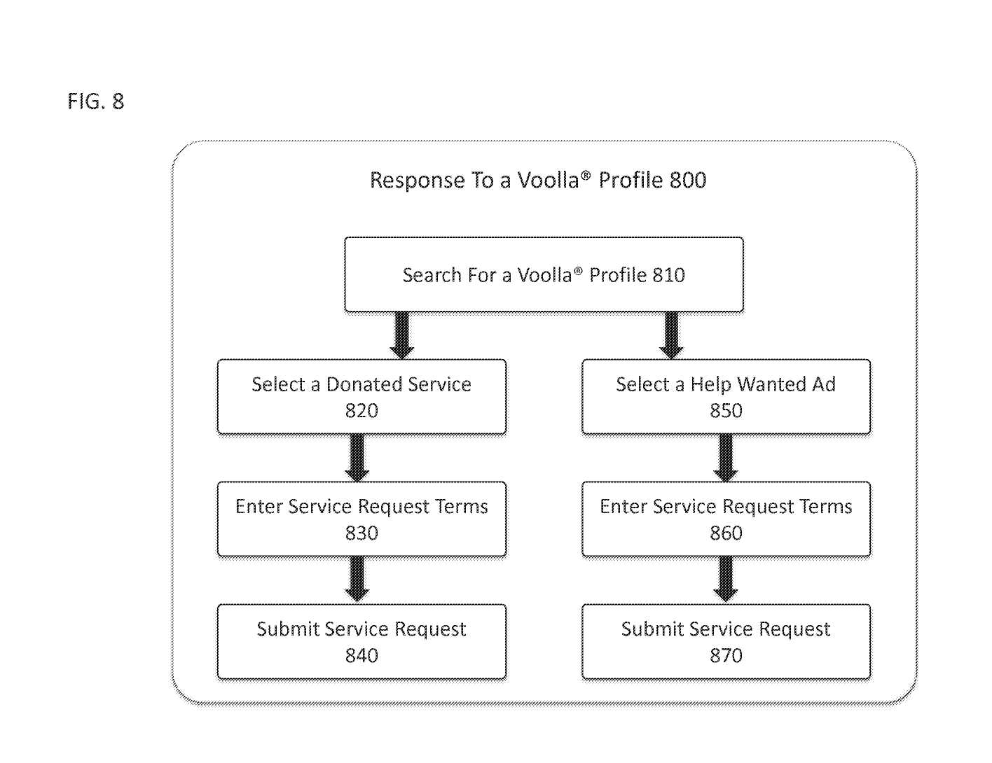

FIG. 8 is a flowchart illustrating an exemplary response 800 by a user of the Voolla® system 100 to a service 250 offered or project 320 proposed by another user of the Voolla® system 100. In certain preferred embodiments of the present invention, the response 800 begins when a user searches for profiles of other users at step 810. As discussed above, in certain embodiments, the search 810 may be performed by entering a search query on a public Internet search engine or an internal search engine of the Voolla® system 100. In certain other embodiments of the present invention, the search 810 may comprise browsing through user profiles categorized by criteria including but not limited to geographical location, category (for example, volunteer vs. customer), experience, preferred non-profit organizations, user ratings, the total amount of contributions raised for non-profit organizations, and other criteria. In other preferred embodiments of the present invention, the user profiles may be suggested by Voolla® system 100 based on: previous or current projects 320 worked on by the user or previous or current services 250 utilized by the user; the user profile matching criteria designated in an “alert” set by the user; or the user profile containing the same or similar preferred non-profit organizations 234 as the one or more approved non-profit organizations 234 selected by the user as desired beneficiaries of contributions.

In certain preferred embodiments of the invention, once the user has searched for and found a desired user profile in step 810, the user can then select a service 250 offered by that profile in step 820 or choose to select a project or Help Wanted Ad proposed by that profile in step 850. If the user is a customer 170 who selects a desired service 250 in step 820, that customer 170 can then enter the terms of a service request for the desired service at step 830 and submit that service request to the Voolla® system 100 at step 840 to begin the negotiation process with the volunteer 160 offering the selected service 250. If the user is a volunteer 160 that has selected a desired proposed project 320 in step 850, that volunteer 160 can then enter the terms of a service request for the desired proposed project at step 860 and submit that service request to the Voolla® system 100 at step 870 to begin the negotiation process with the customer 170 offering the desired proposed project 320.

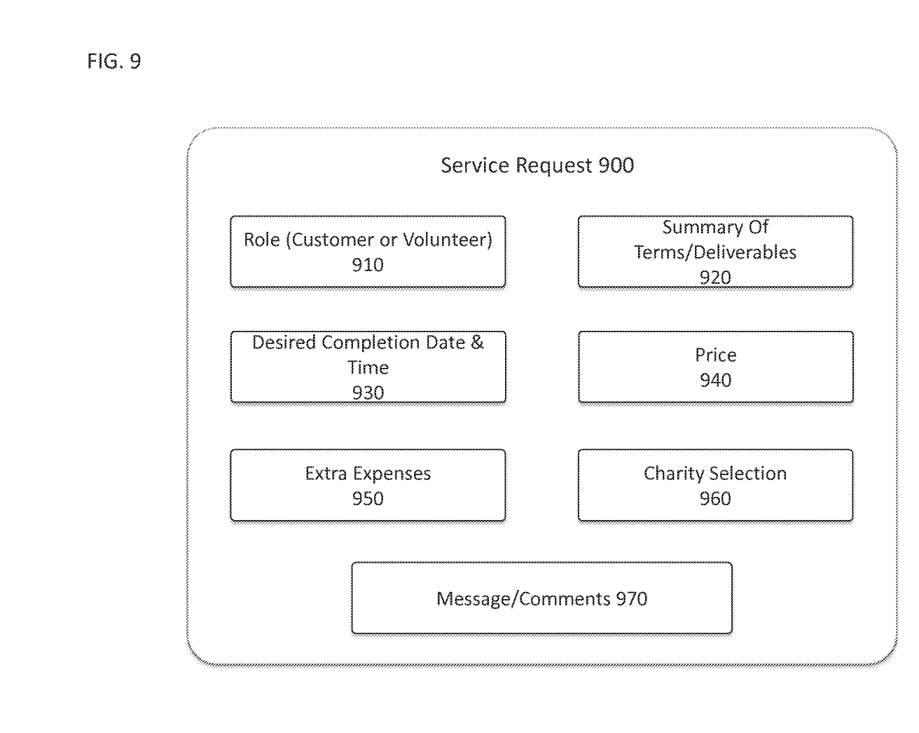

FIG. 9 illustrates an exemplary service request 900 of preferred embodiments of the present invention in response to a posted service 250 or proposed project 320. In preferred embodiments of the present invention, the service request 900 comprises the role (customer or volunteer) of the user submitting the service request 910, a summary of terms/deliverables 920 for the project proposed in the service request 900, a desired completion date and time 930 for the project proposed in the service request 900, a proposed price 940 for the project proposed in the service request 900, any extra expenses 950 for the project proposed in the service request 900 (for example, materials or fees required to complete a project), a selection of the one or more charitable non-profit organizations 960 that will benefit from financial contributions in return for the services performed in the project proposed in the service request 900, and any messages/comments 970 from the user submitting the service request 900.

In certain embodiments of the invention, the service request 900 may be for a complex project that requires the services 250 of multiple volunteers 160. The service request 900 may comprise multiple different prices 940, expenses 950, terms/deliverables 920, and completion dates & times 930, each corresponding to a particular service 250 provided by a particular volunteer 160 working on the complex project.

In certain preferred embodiments of the present invention, the one or more charitable non-profit organizations 960 may each receive a monetary contribution comprising a percentage of the total price 940 for the project contained in the service request 900. In one preferred embodiment, the contributions are divided equally amongst the one or more charitable non-profit organizations 960. In another preferred embodiment, the user submitting the service request 900 can select a percentage of the total price from 1-100% for each of the non-profit organizations 960 to receive as a contribution. In certain preferred embodiments, one of the charitable non-profit organizations 960 is the Voolla® system 100 itself. In certain embodiments, the Voolla® system 100 can receive a percentage or amount of the total price fixed by the Voolla® system 100 itself. In other embodiments, the Voolla® system 100 receives a percentage of the total price selected by the user submitting the service request 900.

In certain preferred embodiments of the present invention, the volunteer 160 performing the service contained in the service request 900 can request that at least a portion of the price 940 of the service be direct financial compensation to the volunteer 160 at a market or reduced rate for the volunteer 160's services. However, unlike the contributions made to the non-profit organizations 960, this direct financial compensation will subject the volunteer 160 to income tax liability.

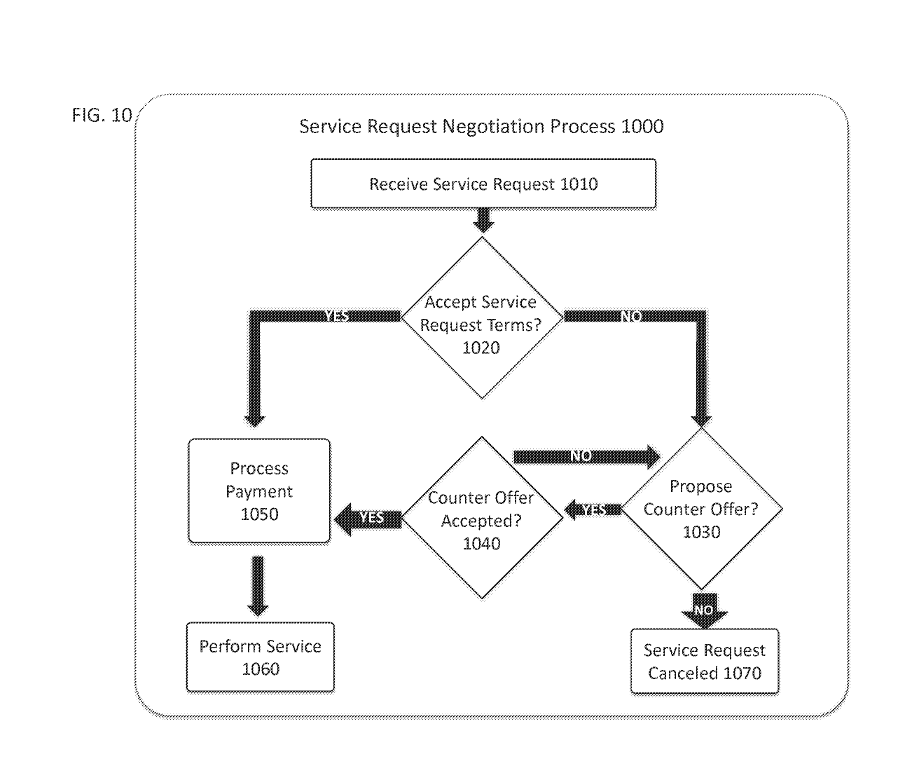

FIG. 10 is a flowchart illustrating an exemplary negotiation process 1000 for negotiating the final terms of a service request 900 in preferred embodiments of the Voolla® system 100. Once a service request 900 has been submitted and received by one or more users at step 1010, the one or more users who are the recipients of that service request 900 can decide whether to accept the terms of that service request at step 1020. If the user decides to accept the service request's terms at step 1020, the process moves to step 1050, where payment is submitted by the customer 170 to the Voolla® system 100 and processed. Once the processing of step 1050 is complete, the volunteer 160 performs the requested service(s) at step 1060.

If the user does not accept the terms of the original service request 900 at step 1020, the user may decide to propose a counter-offer at step 1030 of the negotiation process 1000. If the user opts not to propose a counter-offer, the service request is canceled at step 1070. If the counter-offer is accepted by the other user at step 1040, then the process moves to step 1050 as described above. If the counter-offer is not accepted at step 1040, the user receiving the counter-offer has the option to propose a counter-offer of their own at step 1030.

Like the original service request 900, the user's counter-offer takes the form of a service request 900 submitted to the user who submitted the original service request 900. In the counter-offer service request 900, the user can modify the terms/deliverables 920, the desired completion date or time 930, the price 940, the amount of extra expenses 950, and may change the selection of non-profit recipients 960 by selecting a different charity, adding/subtracting charity selections, or changing the percentage distribution of contributions from the selection 960 made in the original offer. The user may also include their own message or comments 970.

In certain embodiments of the present invention, if the customer 170 and the one or more volunteers 160 are unable to agree on a non-profit organization 960, the Voolla® system 100 may suggest one or more non-profit organizations 960 that are similar to both the one or more preferred non-profit organizations of the customer 170 as well as the preferred non-profit organizations of the volunteer(s) 160. For example, if the volunteer 160 proposed that the price 940 of the project be contributed to a charitable organization 960 that supports hunters, while customer 170 disagreed and proposed that the price 940 be contributed to an organization 960 dedicated to the prevention of animal cruelty, the Voolla® system 100 could suggest a compromise on an organization 960 that was dedicated to the protection of environmental habitats, which would be in the interests of both the customer 170 and the volunteer 160.

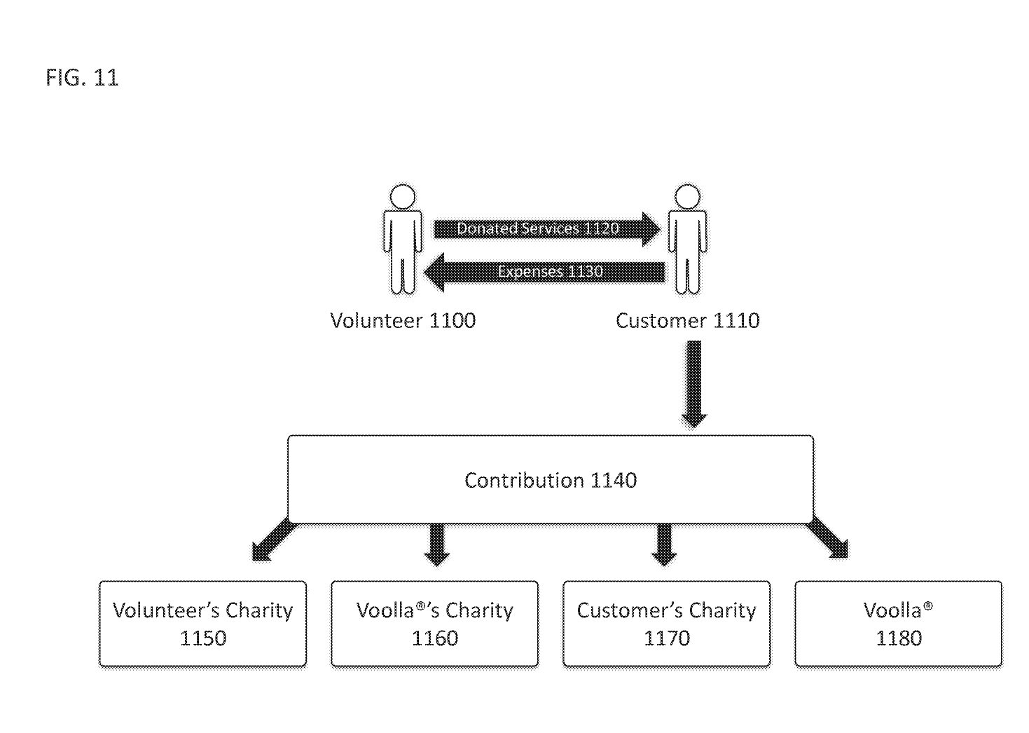

FIG. 11 illustrates the various transactions that occur in an exemplary preferred embodiment of steps 1050 and 1060 of FIG. 10. The volunteer 1100 provides the donated services specified in the service request 1120 to complete the project proposed by customer 1110. In return, the customer 1110 pays for the expenses of the project 1130, as well as provides a monetary contribution 1140 to one or more charities 1150 selected by the volunteer 1100, charities 1160 selected by the Voolla® system, or charities 1170 selected by the customer 1110, and/or to the non-profit organization operating the Voolla® system 1180. In an exemplary preferred embodiment, the monetary contribution 1140 is provided through the Voolla® system 1180, and the non-profit status of the organization operating the system 1180 exempts volunteer 1100 from income tax liability.

In certain embodiments of the present invention, the computer-implemented systems and methods may be implemented in hardware, software, firmware, or any combination thereof. If implemented in software, the software may be stored on or transmitted over one or more instructions or code on computer-readable media. Computer-readable media includes both computer storage media and communication media including any medium that facilitates transfer of a computer program from one place to another. Computer storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-Ray disc where disks usually reproduce data magnetically, while discs reproduce data optically with lasers. Combinations of the above should also be included within the scope of computer-readable media.

The preceding examples are only illustrative. It will be readily seen by one of ordinary skill in the art that the present invention fulfills all of the objectives set forth above. After reading the foregoing specification, one of ordinary skill will be able to effect various changes, substitutions of equivalents, and various other aspects of the invention as broadly disclosed therein. It is therefore intended that the protection granted herein be limited only by the definition contained in the appended claims and equivalents thereof.

What is claimed is:

1. A computer-implemented system for facilitating the performance of services in exchange for charitable contributions, comprising:
at least one server providing access to the computer-implemented system;
at least one database comprising profiles for a plurality of users and records for a plurality of approved non-profit organizations;
a first computing device utilized by a first user, the first user having a profile in the computer-implemented system, to access the computer-implemented system;
a second computing device utilized by a second user, the second user having a profile in the computer-implemented system, to access the computer-implemented system,
wherein the first user and second user reach an agreement, via the computer-implemented system, the agreement comprising the performance of at least one service by the first user in exchange for a contribution to at least one of the plurality of approved non-profit organizations by the second user.

2. The computer-implemented system of claim 1, wherein the first user's profile in the computer-implemented system comprises at least one service offered by the first user.

3. The computer-implemented system of claim 2, wherein the first user's profile in the computer-implemented system further comprises at least one service requested by the first user.

4. The computer-implemented system of claim 1, wherein the second user's profile in the computer-implemented system comprises at least one service requested by the second user.

5. The computer-implemented system of claim 4, wherein the second user's profile in the computer-implemented system further comprises at least one service offered by the second user.

6. The computer-implemented system of claim 1, wherein the first and second computing devices are computing devices selected from the group consisting of desktop computers, laptop computers, mobile computers, tablet computers, cellular telephones, smartphones, internet-enabled televisions, personal digital assistants, and video game consoles.

7. The computer-implemented system of claim 1, wherein the plurality of users comprise individuals, businesses, and non-profit organizations.

8. The computer-implemented system of claim 1, wherein the server provides access to the computer-implemented system via one or more of a website, an official application, a plugin, and a third-party application.

9. The computer-implemented system of claim 1, further comprising a third computing device utilized by an approved non-profit organization to access the computer-implemented system.

10. The computer-implemented system of claim 1, wherein the agreement further comprises a payment by the second user to the first user.

11. The computer-implemented system of claim 1, wherein the at least one of the plurality of approved non-profit organizations is selected by one of the group consisting of the first user, the second user, and the computer-implemented system.

12. The computer-implemented system of claim 1, wherein the contribution to at least one of the plurality of approved non-profit organizations comprises a contribution to multiple approved non-profit organizations.

13. The computer-implemented system of claim 12, wherein each of the multiple approved non-profit organizations receives from 1% to 99% of the total amount of the contribution to the multiple approved non-profit organizations.

14. The computer-implemented system of claim 12, wherein one of the multiple approved non-profit organizations is the operator of the computer-implemented system.

15. The computer-implemented system of claim 12, wherein a first one of the multiple approved non-profit organizations is selected by the first user, and a second one of the multiple approved non-profit organizations is selected by the second user.

16. The computer-implemented system of claim 1, wherein at least one of the profiles of the first user and the second user comprises a user selection of at least one user-preferred non-profit organization from the plurality of approved non-profit organizations.

17. The computer-implemented system of claim 16, wherein the computer-implemented system suggests one or more approved non-profit organizations similar to the at least one user-preferred non-profit organization.

18. The computer-implemented system of claim 17, wherein the first user's profile comprises a first user-preferred non-profit organization, the second user's profile comprises a second user-preferred non-profit organization, and the contribution to at least one of the plurality of approved non-profit organizations is a contribution to a non-profit organization similar to both the first user-preferred non-profit organization and the second user-preferred non-profit organization and suggested by the computer-implemented system.

19. The computer-implemented system of claim 1, further comprising a financial fiduciary account for holding at least a portion of the contribution until the performance of the at least one service is completed.

20. The computer-implemented system of claim 1, wherein the computer-implemented system is operated by a non-profit organization.

21. A computer-implemented method for facilitating the performance of services in exchange for charitable contributions, comprising:
creating a first profile by a first user on a computer-implemented system via a first computing device;
creating a second profile by a second user on the computer-implemented system via a second computing device;
reaching an agreement between the first user and the second user via the computer-implemented system, the agreement comprising an agreement by the first user to perform at least one service in exchange for an agreement by the second user to make a contribution to at least one of a plurality of non-profit organizations.

22. The computer-implemented method of claim 21, wherein the first user is not subject to income tax liability for the contribution made by the second user in exchange for the at least one service performed by the first user.
